(19) United States
(12) Patent Application Publication
(10) Pub. No.: US 2021/0056555 A1
(43) Pub. Date: Feb. 25, 2021

(54) SYSTEMS AND METHODS FOR USE IN AUTHENTICATING USERS BASED ON VEHICLE PROFILES

(71) Applicant: MASTERCARD INTERNATIONAL INCORPORATED, Purchase, NY (US)

(72) Inventors: Marek Kurylko, Bloomfield, NJ (US); Eugene Reda, Little Falls, NJ (US); Joseph Hayes, Montclair, NJ (US)

(21) Appl. No.: 16/935,794

(22) Filed: Jul. 22, 2020

Related U.S. Application Data
(60) Provisional application No. 62/890,787, filed on Aug. 23, 2019.

(51) Int. Cl. G06Q 20/40; G06Q 20/32; G06F 21/31; G06F 21/35; B60W 40/08

(52) U.S. Cl. CPC G06Q 20/40145; G06Q 20/3278; G06Q 20/4093; B60W 2540/043; G06F 21/35; B60W 40/08; G06F 21/316

(57) ABSTRACT

Systems and methods are provided for authenticating users based on user vehicle profiles. On exemplary method includes capturing vehicle data for a user during a driving session of the user at a vehicle, where the vehicle data is associated with at least one of: a steering wheel, a turn signal, a seat, and an entertainment system of a vehicle. The method also includes, in response to a request to authenticate the user during the driving session, comparing the vehicle data captured during the driving session to a user vehicle profile associated with an identified user stored in a memory and emitting, via wireless network adapter, a token associated with the user vehicle profile, during the driving session, in response to the vehicle data captured during the driving session substantially matching the user vehicle profile, thereby indicating authentication of the user as the identified user.

### CROSS-REFERENCE TO RELATED APPLICATION

This application claims the benefit of, and priority to, U.S. Provisional Application No. 62/890,787 filed on Aug. 23, 2019. The entire disclosure of the above application is incorporated herein by reference.

### FIELD

The present disclosure generally relates to systems and methods for compiling vehicle profiles for users and authenticating the users based on the vehicle profiles.

### BACKGROUND

This section provides background information related to the present disclosure which is not necessarily prior art.

Users are known to be associated with identities, which may be used to acquire accounts associated with the users. For example, an email account may be issued to a user based on one or more attributes of his/her identity (e.g., based on his/her name, phone number, etc.), and then used to send and receive emails. Often, access to the email account is limited to the user by way of a username and password, by which the user is authenticated. For other types of accounts, such as, for example, payment accounts, different authentication techniques may be employed to inhibit use of the accounts by unauthorized users. Such techniques may include, for example, use of personal identification numbers (PINs), passcodes, biometrics (e.g., fingerprints, facial images, etc.), etc. to confirm that the users requesting access to the accounts are authorized to do so. It is thus known for authentication techniques to rely on information possessed or known to the users as means for ensuring that only authorized users are provided access to their accounts.

### DRAWINGS

The drawings described herein are for illustrative purposes only of selected embodiments and not all possible implementations, and are not intended to limit the scope of the present disclosure.

FIG. 1 is a block diagram of an exemplary system of the present disclosure suitable for use in generating vehicle profiles for users and for authenticating the users, based on the vehicle profiles, in connection with account access by the users;

FIG. 2 is a block diagram of a computing device that may be used in the exemplary system of FIG. 1; and

FIG. 3 is a flow diagram of an exemplary method, suitable for use in the system of FIG. 1, for authenticating a user based on a vehicle profile compiled for the user at a vehicle.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

User authentication is often required in connection with access to different accounts. The degree of authentication may be based on the types of accounts for which access is requested, or the particular types of access desired. For example, a biometric authentication may be required for a payment account transaction over a given threshold, while a signature authentication may be required for a lower value payment account transaction. Regardless, the authentication of the user requires one or more inputs from the user, specific to the user and the transaction. Alternatively, limited authentication of the user may be implemented in some scenarios, whereby a potential for fraud may be increased.

Uniquely, the systems and methods herein provide a new manner for authenticating users. The systems and methods herein rely on vehicle profiles for authentication of users, for example, in connection with account access associated with the vehicle (e.g., in connection with the user accessing an account while the user is present in the vehicle, etc.). In particular, when a user is identified in a vehicle, the vehicle captures vehicle data (e.g., hand position, pressure, turn signal usage, etc.) for the user and compiles a profile for the user in the vehicle (e.g., a user vehicle profile, etc.). When the profile is stored, it may then subsequently be relied on to authenticate the user during a driving session. In one example, a payment token may be provisioned to the vehicle, whereby upon authentication of the user (based on the user's profile and based on vehicle data for the user from a current driving session), the payment token may be released to a merchant (e.g., wirelessly emitted (e.g., via NFC, etc.) from a side mirror, an antenna, a hood ornament, another part of a vehicle, etc.). In this manner, a low or no friction mechanism is created for authenticating the user when driving the vehicle. The authenticating inputs received from the user as the basis for authenticating the user are the common inputs to the vehicle already (e.g., use of turn signals, grip pressure on the steering wheel, radio stations, etc.), and which are unique to the user. The lack of need for other conventional authentication inputs from the user minimizes or removes distraction to the user in authenticating himself/herself, but still provides sufficient confidence to accept transaction values, for example, associated with vehicle payment by the user (or other account access requests).

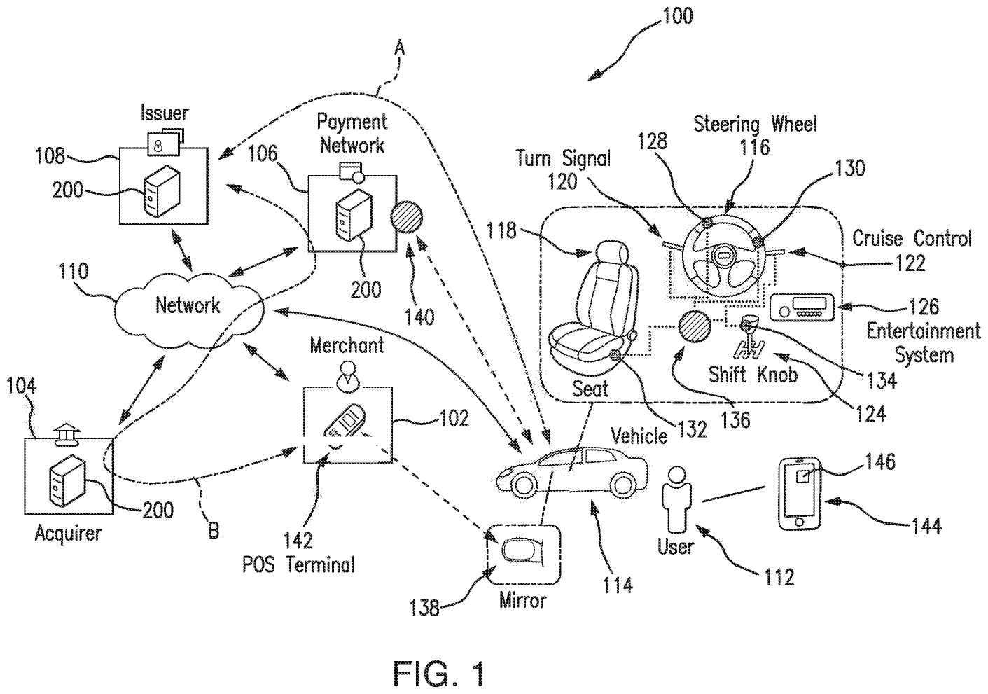

FIG. 1 illustrates an exemplary system 100, in which one or more aspects of the present disclosure may be implemented. Although, in the described embodiment, the system 100 is presented in one arrangement, other embodiments may include the system 100 arranged otherwise, depending, for example, on processing of payment account transactions, connectivity associated with vehicles, different users of the vehicles, etc.

Referring to FIG. 1, the system 100 generally includes, in connection with facilitating payment account transactions, a merchant 102, an acquirer 104 associated with the merchant 102, a payment network 106, and an issuer 108 configured to issue payment accounts to users (e.g., consumers, etc.), each of which is coupled to network 110. The network 110 may include, without limitation, a wired and/or wireless network, a local area network (LAN), a wide area network (WAN) (e.g., the Internet, etc.), a mobile network, and/or another suitable public and/or private network capable of supporting communication among two or more of the illustrated parts of the system 100, or any combination thereof. In one example, the network 110 includes multiple networks, where different ones of the multiple networks are accessible to different ones of the illustrated parts in FIG. 1. In this example, the network 110 may include a private payment transaction network made accessible by the payment network 106 to the acquirer 104 and the issuer 108 and, separately, a public network (e.g., the Internet, etc.) through which the merchant 102 and the acquirer 104, and/or other parts of the system 100 (e.g., a user 112, a vehicle 114, etc.) may communicate.

In the system 100, the merchant 102 offers products (e.g., goods and/or services, etc.) for sale to users, such as the user 112. When the user 112 desires to purchase one or more products from the merchant 102, the acquirer 104, the payment network 106 and the issuer 108 are configured, as described in more detail below, to facilitate the transaction, whereby the one or more products is/are funded by a payment account issued to the user 112 by the issuer 108.

As shown in FIG. 1, the system 100 includes the vehicle 114, which may include any type of vehicle such as, without limitation, a car, a truck, a van, a motorcycle, a bus, a recreational vehicle (RV), a commercial truck, etc. In this exemplary embodiment, the vehicle 114 belongs to the user 112 or an associate of the user 112 (e.g., a friend, an employer, a family member, etc.). It should be appreciated that the user 112 may be associated with the vehicle 114 in one or more other ways (e.g., where the vehicle 114 is a rental vehicle, etc.), whereby the user 112 may be an operator of the vehicle but not the owner of the vehicle 114 (and/or, for example, where the vehicle 114 is shared among multiple different and/or unrelated users, etc.).

In this example, the vehicle 114 includes an interior, where the user 112 is situated to operate the vehicle 114. Different components of the interior of the vehicle 114 are illustrated in FIG. 1 in the dotted box (without limitation). Specifically, the interior of the illustrated vehicle 114 includes a steering wheel 116, a driver's seat 118, a turn signal 120, cruise control 122, a shift knob 124 (which may be optional, for example, as applicable for manual transmission vehicles or which may instead represent a shifter for automatic transmission vehicles), an entertainment system 126 (e.g., a stereo, a CD player, an audio file plyer, a movie or other media player, etc.), etc. While the entertainment system 126 is generally limited to the entertainment features of the vehicle 114, the vehicle 114 may include other systems such as climate control systems, etc., whereby the media control and the climate control of the vehicle 114 are controlled through an integrated system (e.g., whereby both the climate and the media of the vehicle 114 may be controlled by way of the entertainment system 126, etc.).

The vehicle 114 also includes multiple sensors 128-134. In this exemplary embodiment, the sensors 128-130 are integrated into the steering wheel 116, whereby the sensors 128-130 include pressure sensors configured to determine the pressure of the user's grip on the steering wheel 116 and/or the position of the user's hands on the steering wheel 116 during a driving session. The sensor 132 is disposed at least partially within the seat 118 and is configured to measure at least one characteristic of the user 112 at the seat 118 (e.g., weight, temperature, size, sitting position, etc.), whereby the sensor 132 may include a temperature sensor, a pressure sensor, a combination thereof, etc. And, the sensor 134 is integrated at least partially into the shift knob 124, whereby the sensor 134 is configured to determine the pressure and/or grip strength and/or position of the user's hand while holding and/or shifting the transmission of the vehicle 114 from gear to gear. It should be appreciated that while only two sensors 128-130 are include in the steering wheel 116, one sensor 132 is included in the seat 118, and one sensor 134 is included in the shift knob 124, a different number of sensors, or the same or different types of sensors, may be employed in the steering wheel, seat, shift knob, and/or in/at other components of the vehicle 114 with which the user 112 interacts. For example, the steering wheel 116 may include multiple additional sensors positioned around and/or throughout the steering wheel 116 or a single sensor extending around the steering wheel 116 (e.g., like a web working around the entire steering wheel 116, etc.) to more accurately determine grip position and/or pressure of a given user's interaction with the steering wheel 116. Similarly, additional sensors may be associated with the seat 118, the shift knob 124 (e.g., positioned throughout the entire seat 118 and/or shift knob 124 or on a substantial portion thereof; etc.), etc. And further, sensors may be associated with armrests of the vehicle 114, pedals of the vehicle 114, etc.

It should be appreciated that the specific components and sensors shown in FIG. 1 are merely exemplary in nature. And, any component of the vehicle 114 to which the user 112 provides an input may be relied on herein for input data from (or associated with) the user 112. What's more, the input (as described herein) may be received directly by the vehicle 114 or it may be determined through one or more sensors. For example, the turn signal 120 being toggled for a left turn may be captured from a processor controlling the turn signal indicators in a dash of the vehicle 114, rather than from a sensor associated with the turn signal 120 handle. The same may apply to the entertainment system 126, a climate control system, memorized seat position(s) (per a key fob, or not), rotation of the steering wheel 116, interaction(s) with the brake and/or gas pedals, positions of mirrors (e.g., side mirror 138, a rearview mirror, etc.), etc. Conversely, pressure applied by the user 112 to the seat 118 (or even the position of the seat) or the position of a rearview mirror of the vehicle 114 may be more commonly determined through use of sensors.

In at least one embodiment, the vehicle 114 may be configured to capture a biometric from the user 112, such as, for example, a fingerprint, a heartrate, etc., via one or more of the sensors 128-130 included in the steering wheel 116, or the sensor 134 included in the shift knob 124, etc. In another example embodiment, the vehicle 114 may include one or more microphone devices, which may be configured to capture a voice biometric of the user 112 (in general, or at a specific location within the vehicle 114 (e.g., at the driver's seat 118, etc.)). It should be appreciated that biometric reference data (i.e., specific to the user 112) may be provisioned and/or otherwise stored in the vehicle 114 for authenticating the user 112. That said, this biometric data is not specific to and/or necessarily related to the user's use of the vehicle 114, and thus is not considered vehicle data herein. Rather, it is referred to as biometric data (and broadly is included in the data referred to herein).

With continued reference to FIG. 1, the vehicle 114 also includes an authentication hub 136, which is configured to capture data from the sensors 128-134, and also from one or more processors controlling other components of the vehicle 114, such as, for example, the seat 118, the turn signal 120, the cruise control 122, the entertainment system 126, etc.

As shown by the dotted lines, the authentication hub 136 is included as a computing device in the vehicle 114 in the illustrated embodiment. That said, the authentication hub 136 may be included as a computing device in the payment network 106, in whole or in part, in association with an authentication hub server 140, or in the issuer 108, in whole or in part. Regardless of its location, though, it should be appreciated that various divisions of operations between the authentication hub 136 and the authentication hub server 140 may be included in various different embodiments (and as generally described below). Additionally, the authentication hub 136 may include a network-based application. In particular, the authentication hub 136 may include, or may be provided as part of, an electronic wallet, or e-wallet (or virtual wallet), application such as, for example, Masterpass® from MasterCard, Apple Pay® from Apple, Samsung Pay® from Samsung, etc., or other application suitable to provide a payment account credential. Further, the authentication hub 136 may include one or more other network-based applications specific to the vehicle 114 (e.g., the Fordpass® application, the myAudi® application, etc.).

In connection therewith, the user 112 is associated with a communication device 144 that includes such an application 146 specific to the vehicle 114 (e.g., the Fordpass® application, the myAudi® application, etc.). The user vehicle profile may be identified to the user 112 via the application 146 (e.g., a mobile phone number, an application ID, etc.) (potentially paired with the vehicle 114), whereby the application 146 may be involved and/or associated with the compilation of the user vehicle profile specific to the user 112 (e.g., by way of learning sessions, etc.). As needed, depending on the particular implementation of the authentication hub 136 (e.g., integrated in part in the application 146 or not, etc.), the user vehicle profile, or part thereof, may be shared with the authentication hub 136 and/or the authentication hub server 140 (e.g., via the communication device 144, etc.). What's more, the application 146 may participate in the provisioning of payment methods (e.g., payment accounts, payment account credentials, etc.) to the vehicle 114. For example, the application 146 may include, or be part of, a virtual wallet, and configured to cooperate with the issuer 108 and/or the payment network 106 to provision the payment methods to the vehicle 114 for use during a purchase transaction as described herein. Regardless, the communication device 144 may therefore provide a mechanism for identifying the user 112 in the vehicle 114 against other potential users.

In operation in the system 100, in connection with use of the vehicle 114, the user 112 requests a user vehicle profile be compiled, for example, via the authentication hub 136, which may include a network-based application included in the vehicle 114 (as accessible through a computing device of the vehicle 114 (e.g., as part of the entertainment system 126, etc.) or as accessible through the communication device 144 of the user 112 (e.g., a smart phone, etc.)). The request may include a name, address, phone number, email address, and/or other data associated with the user 112 (broadly, identity attributes of the user 112). In response to the request, the vehicle 114, and in particular, the authentication hub 136, is configured to capture data for the user 112 over an interval when the user 112 begins operating the vehicle 114 (e.g., as learning logic, etc.), and then compile the captured data. In general, the range of the interval over which the data is captured will last until a sufficient level of consistency in user behavior within the vehicle 114 (and in operating the vehicle 114) has been achieved to merit (or provide ability to determine) a positive identification of the user 112 from other users.

In compiling the user vehicle profile, it should be appreciated that the user 112 may be distinguished from other users of the vehicle 114 by an input from the user 112 received by the vehicle 114 and/or by the authentication hub 136 (e.g., by way of the network-based application, etc.), by a specific key fob for the vehicle 114, or based on segregation of the user vehicle data from others, etc.

When sufficient vehicle data has been captured for the user 112, the vehicle 114, and specifically, the authentication hub 136, is configured to compile the captured data into the user vehicle profile and to notify the user 112 of the user vehicle profile. It should be appreciated that, in some embodiments, the authentication hub 136 may be configured to communicate with the authentication hub server 140 and that the authentication hub server 140 may then be configured to compile the user vehicle profile (rather than the authentication hub 136), whereby the authentication hub 136 is configured to transmit the captured vehicle data to the authentication hub server 140 (when sufficient vehicle data has been captured) and to receive and store the user vehicle profile from the authentication hub server 140.

In this exemplary embodiment, apart from compiling the profile for the user 112, the authentication hub 136 is also configured to employ the user vehicle profile in order to authenticate the user 112 in connection with payment account transactions. Initially, to use the vehicle 114 as a payment device, the authentication hub 136, and more generally, the vehicle 114, is configured to request a payment account credential (associated with the user's payment account) be provisioned to the vehicle 114. Specifically, the user 112 is associated with the payment account issued by the issuer 108, and the user 112 instructs the vehicle 114 to request a payment account credential for the payment account be provisioned to the vehicle 114 (e.g., to the authentication hub 136, etc.). In response, the vehicle 114 is configured to initiate a payment account credential request, via a network-based application included therein (e.g., the same or different application at the entertainment system 126, etc.), with the issuer 108 (or, potentially, the payment network 106, directly or indirectly). The request may include personal identifying information known to the vehicle 114 for the user 112 and a primary account number (PAN) for the user's payment account.

In response, the issuer 108 is configured to verify the request with the user 112, for example, with a message to a computing device known to be associated with the user 112 (e.g., a text message to a phone number associated with the payment account (e.g., for the communication device 144, etc.), etc.). When the user replies, with a verification, the issuer 108 is configured to provision a payment account credential (e.g., a payment token, etc.) to the vehicle 114, along path A. Upon receipt, the vehicle 114 is configured to store the payment account credential in memory (e.g., in a secure element therein, etc.). In this manner, the payment account credential is provisioned to the authentication hub 136 and/or the vehicle 114, whereby subsequent use of the payment account credential is conditioned on an authentication of the user 112 based on the user vehicle profile for the user 112 by the authentication hub 136.

Then, when the user 112 gets into the vehicle 114, starts an engine of the vehicle 114 and begins to drive (e.g., drives along a route, etc.), the user 112 initiates a driving session. In connection therewith, the authentication hub 136 is configured to capture and store vehicle data during the driving session (e.g., in memory associated with the authentication hub 136, etc.). After an initial interval of the driving session, the user 112 may pull into the merchant 102 to make a purchase. The user 112 may initiate the purchase, funded by the payment account provisioned to the vehicle 114, while the user 112 is associated with the vehicle 114 (e.g., in or near the vehicle, etc.). For example, when the merchant 102 is a fast food merchant, the user 112 may pull into a drive through of the merchant 102 and order. In turn, the user 112 will be required to submit payment for his/her order. As such, the user 112 selects to purchase with the payment account credential stored in the vehicle 114 (e.g., via an input to a vehicle pay option at a presentation and/or input device of the vehicle 114 (e.g., at the entertainment system 126, etc.), etc.). In doing so, the vehicle 114 is configured to submit a request for the payment account credential to the authentication hub 136, as part of a request to authenticate the user 112 (i.e., authentication is required to access the payment account credential).

Upon receipt of the request, the authentication hub 136 is configured to compare the captured vehicle data for the instant driving session (i.e., a current driving session) to the corresponding data in the user vehicle profile. When a sufficient match exists, the user 112 is authenticated, and the vehicle 114 is permitted to provide a payment token for the user's payment account to the merchant 102. In this exemplary embodiment, the vehicle 114 includes the side mirror 138, which includes a network interface (e.g., RFID interface, etc.) and is configured to wirelessly emit at least the payment token and, potentially, a device identifier for the vehicle 114, from the side mirror 138 to the merchant 102. The vehicle 114 may further be configured to emit an authentication token, which may be indicative of the type of authentication and/or the source of authentication of the user 112, etc.

It should be appreciated that in various embodiments, the authentication token or other information emitted from the vehicle 114 may be encrypted or otherwise protected (e.g., by a key or certificate provisioned to the vehicle 114 and/or the authentication hub 136, etc.). It should also be appreciated that in other embodiments, the vehicle 114 may include one or more other parts and/or structures and/or devices (e.g., other than the side mirror 138 or in addition thereto, etc.), which include a network interface (e.g., a RFID interface, etc.) and are configured to wirelessly emit at least the payment token and, potentially, a device identifier for the vehicle 114, therefrom to the merchant 102 (e.g., an antenna, a hood ornament, a headlight, a taillight, etc.).

The merchant 102, in turn, includes a point-of-sale (POS) terminal 142, which is moved and/or disposed in close proximity to the side mirror 138 (e.g., by manipulation by an employee of the merchant 102, or based on a mounting position, etc.) (e.g., within inches, or potentially centimeters, etc.). The POS terminal 142 is configured to capture the user's payment token and a device ID for the vehicle 114 (and potentially an authentication token) from the side mirror 138. In turn, the POS terminal 142 (broadly, the merchant 102) is configured to compile and then to communicate an authorization request for the transaction (e.g., including the payment token, the device ID for the vehicle 114, the authentication token (if applicable), and an amount of the purchase, etc.) to the acquirer 104. The authorization request is transmitted along path B in the system 100. The acquirer 104 communicates the authorization request with the issuer 108, through the payment network 106, such as, for example, through MasterCard®, VISA®, Discover®, American Express®, etc., to determine whether the payment account is in good standing and whether there is sufficient funds and/or credit to cover the transaction (and potentially to verify, validate or otherwise rely on the authentication token). In turn, if approved, an authorization reply (indicating the approval of the transaction) is transmitted back from the issuer 108 to the merchant 102, along path B, thereby permitting the merchant 102 to complete the transaction with the user 112 (e.g., by delivering the food ordered by the user 112, etc.). The transaction is later cleared and/or settled by and between the merchant 102, the acquirer 104, and the issuer 108. If declined, however, the authorization reply (indicating a decline of the transaction) is provided back to the merchant 102, along path B, thereby permitting the merchant 102 to halt or terminate the transaction, or request alternative forms of payment.

While the authentication hub 136 is included in the vehicle 114 in the example description above, whereby the authentication of the user 112 is local to the vehicle 114, it should be appreciated again that the authentication hub 136 may be integrated, at least in part, with the payment network 106 (e.g., as part of the authentication hub server 140, etc.) and/or with the issuer 108, whereby the authentication of the user 112, based on the user vehicle profile, may be completed, at least in part, away from the vehicle 114. In such embodiments, the vehicle 114, or more specifically, the authentication hub 136, may be configured to transmit vehicle data and to receive an authentication result (e.g., an authentication token, etc.), prior to emitting the payment token to the merchant 102 (to be included in the authorization request, or not).

In certain embodiments, the vehicle 114, and in particular, the authentication hub 136, may be configured to intermittently authenticate the user 112, during a driving session, without a request to do so from the user 112 or the merchant 102, and potentially, to compile/generate an authentication token. In this manner, the vehicle 114 may be configured to respond more promptly to a request for authentication at the merchant 102 or other merchant. It should be further appreciated that when the user 112 parks the vehicle 114, turns off the hub of the vehicle 114 and/or exits the vehicle 114 (e.g., as detected by the sensor 132, etc.), that the driving session is ended. A new driving session, and thus new vehicle data for authenticating the user 112, is initiated the next time that the user 112 enters (re-enters) the vehicle 114 and/or starts the hub of the vehicle 114. It should be appreciated that the stored user vehicle profile will generally only be compared to vehicle data in an instant or current driving session in order to authenticate the user 112.

While in the above example the user 112 and vehicle 114 are physically present at the merchant location, it should be appreciated that the payment account credential may be used, when the user 112 is authenticated, at a virtual location associated with the merchant 102 as well, including through an interface at the vehicle 114, etc. In such embodiments, the payment account token along with, potentially, the authentication token and device ID, may be passed to the merchant 102 via a network communication (e.g., via the virtual merchant location in communication device the vehicle 114, etc.). It should be appreciated that in at least one embodiment, communication with the virtual merchant location may be coordinated by the vehicle 114 through a voice input interface of the vehicle, thereby limiting the impact of the interaction on the attention of the user 112 to driving. Additionally, or alternatively, interactions (or access in general) with the virtual location, via the vehicle 114, may be restricted to instances where the vehicle is parked (in general, or unless voice communication is used).

In various embodiments, the user vehicle profile may be stored at the authentication hub server 140, instead of or in addition to at the authentication hub 136. In such embodiments, it is contemplated that the authentication hub 136 may be configured to retrieve the user vehicle profile (e.g., based on a user identifier (e.g., a phone number, an email address, vehicle ID (e.g., a VIN for the vehicle 114, etc.), etc.), etc.) in order to compare, at the authentication hub 136, the user vehicle profile to the captured vehicle data, for a current or instant driving session, as described above.

What's more, in various embodiments, the user vehicle profile may be portable with the user 112 such that it can be employed across multiple different vehicles, whereby the user vehicle profile is not limited to the vehicle 114. In such embodiments, as above, the vehicle, or specifically the authentication hub in the respective vehicle, would be configured to retrieve the user vehicle profile from the authentication hub server 140 (e.g., based on a user identifier, etc.). In connection therewith, it is contemplated that the user vehicle profile may be normalized based on one or more variables, so as to be compatible with the multiple different vehicles. For instance, various different makes and models of vehicles may be certified to provide consistent levels of data for predetermined vehicle features (e.g., for steering wheels, seats, turn signals, cruise controls, shift knobs, etc.) and/or for corresponding sensors. Additionally, consistent deviations between makes and models of vehicles may also be determined and then matched or accounted for by the authentication hub server 140. For instance, in a Nissan Maxima, a driver may exhibit a grip strength of about 10.5 kg/sensor, but in a Ford Focus, the driver may exhibit a grip strength of about 11.2 kg/sensor, whereby these values may be used to provide normalization between the Nissan Maxima and the Ford Focus (and then whereby they may subsequently be used in comparing captured data from the user 112 for a driving instance (or session) to his/her user vehicle profile). It should be appreciated that certain vehicle data may not be suitable for use in different vehicles, depending, for example, on the extent of differences among the vehicles and/or limitations of measurement of the vehicle data for the user between vehicles (e.g., weight sensors versus no sensors, etc.).

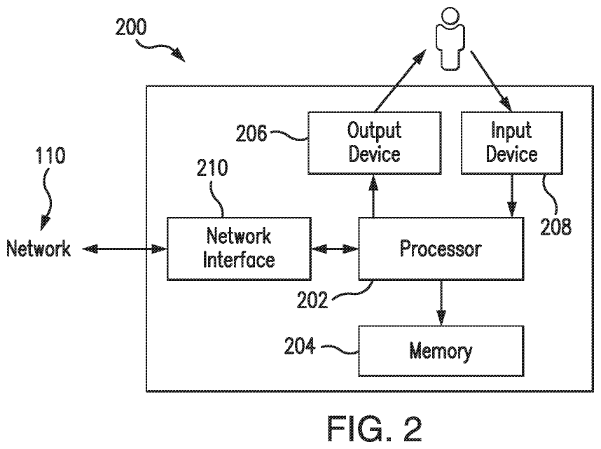

FIG. 2 illustrates an exemplary computing device 200 that can be used in the system 100 of FIG. 1. The computing device 200 may include, for example, one or more servers, workstations, computers, on-board vehicle computers, tablets, laptops, smartphones, PDAs, fobs, POS terminals, vehicles, etc. In addition, the computing device 200 may include a single computing device, or it may include multiple computing devices located in close proximity or distributed over a geographic region, so long as the computing devices are specifically configured to function as described herein. In the exemplary embodiment of FIG. 1, each of the acquirer 104, the payment network 106, and the issuer 108 are illustrated as including, or being implemented in, computing device 200, coupled to the network 110. In addition, the merchant 102 may include or may be implemented in at least one computing device consistent with the computing device 200. And, the vehicle 114 (and each of its various components), the authentication hub 136, the authentication hub server 140, and the POS terminal 142 may each further be considered a computing device consistent with computing device 200. However, the system 100 should not be considered to be limited to the computing device 200, as described below, as different computing devices and/or arrangements of computing devices may be used. In addition, different components and/or arrangements of components may be used in other computing devices.

The exemplary computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, payment account credentials (e.g., tokens, PANs, or other payment credentials, etc.), vehicle data, user vehicle profiles, biometric data, and/or other types of data suitable for use as described herein. Furthermore, in various embodiments, computer-executable instructions may be stored in the memory 204 for execution by the processor 202 to cause the processor 202 to perform one or more of the functions described herein (e.g., one or more of the operations of method 300, etc.), such that the memory 204 is a physical, tangible, and non-transitory computer readable storage media. Such instructions often improve the efficiencies and/or performance of the processor 202 that is performing one or more of the various operations herein, whereby the instructions effectively transform the computing device 200 into a special purpose device. It should be appreciated that the memory 204 may include a variety of different memories, each implemented in one or more of the functions or processes described herein.

In the exemplary embodiment, the computing device 200 includes an output device 206 that is coupled to (and is in communication with) the processor 202. The output device 206 outputs information, either visually or audibly, to a user of the computing device 200, such as, for example, the user 112 in the system 100 when using the vehicle 114, the merchant 102 in the system 100 when the vehicle 114 is presenting the payment token for the user's payment account, etc. It should be further appreciated that various interfaces (e.g., as defined by network-based applications, etc.) may be displayed at computing device 200, and in particular at output device 206, to display such information. With that said, the output device 206 may include, without limitation, a presentation unit such as a liquid crystal display (LCD), a light-emitting diode (LED) display, an LED, an organic LED (OLED) display, or an “electronic ink” display, or the output device 206 may include speakers or any other device suitable to output or present information to the user of the computing device 200, etc.

The computing device 200 also includes an input device 208 that receives inputs from the user (i.e., user inputs) such as, for example, selection of a payment device and/or payment account, etc. The input device 208 is coupled to (and is in communication with) the processor 202 and may include, for example, a keyboard, a pointing device, a mouse, a button, a stylus, a touch sensitive panel (e.g., a touch pad or a touch screen, etc.), a sensor (or a sensor array) (e.g., to detect engine sounds/vibrations, etc.), an RFID reader, another computing device, and/or an audio input device. Further, in various exemplary embodiments, a touch screen, such as that included in a tablet, a smartphone, a vehicle dash, or similar device, behaves as both an output device and an input device. In at least one embodiment, a computing device may omit the output device 206 and/or the input device 208.

In addition, the illustrated computing device 200 also includes a network interface 210 coupled to (and in communication with) the processor 202 and the memory 204. The network interface 210 may include, without limitation, a wired network adapter, a wireless network adapter (e.g., an NFC adapter, a Bluetooth adapter, a Wi-Fi adapter, etc.), a mobile network adapter, or other device capable of communicating to/with one or more different networks, including the network 110. In one example, the network interface 210 includes an RFID reader/interface, etc. Further, in some exemplary embodiments, the computing device 200 includes the processor 202 and one or more network interfaces 210 incorporated into or with the processor 202.

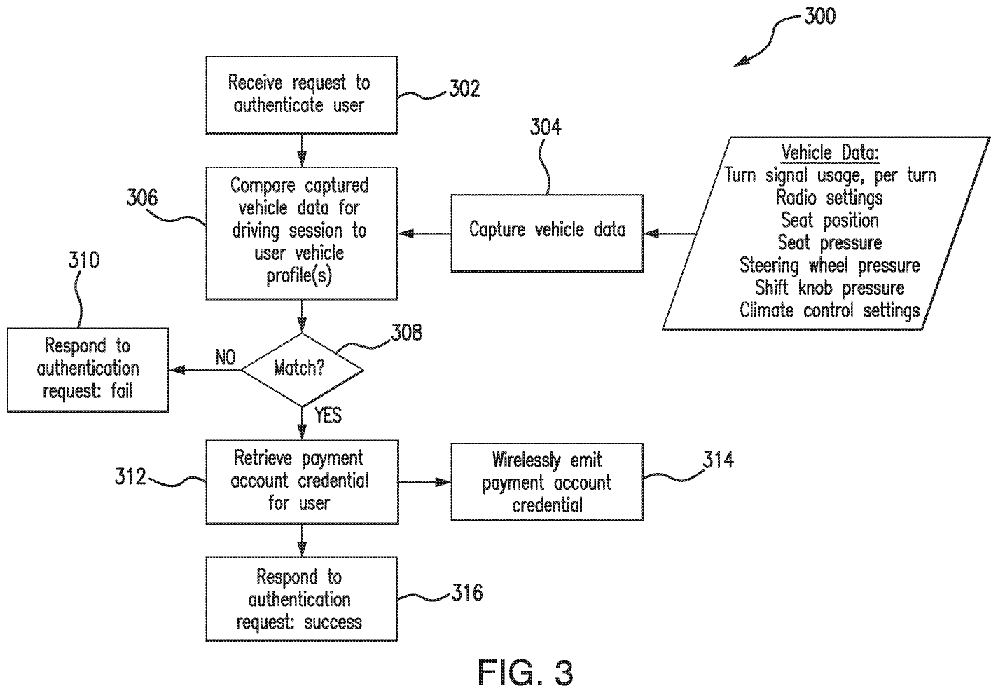

FIG. 3 illustrates exemplary method 300 for authenticating a user based on a vehicle profile compiled for the user at a vehicle. The exemplary method 300 is described with reference to the system 100 and the computing device 200. However, the methods herein should not be understood to be limited to the system 100 and/or the computing device 200. Likewise, the systems and device herein should not be understood to be limited to the method 300.

At the outset, it should be appreciated that the user 112 is registered to the vehicle 114 in two ways. First, the user 112 has identified himself or herself and driven the vehicle 114 for a number of driving sessions, whereby the vehicle 114 (and/or the authentication hub 136) has compiled and stored a user vehicle profile for the user 112 (e.g., in memory associated with the vehicle 114 and/or the authentication hub 136, etc.). In this exemplary embodiment, the vehicle data is identified to the specific user 112 based on a name or identifier provided from the user 112 or based on the communication device 144 specific to the user 112 (e.g., by way of the communication device 144 being disposed within the vehicle 114 and/or by way of pairing between the communication device 144 and/or application 146 and the vehicle 114, etc.). Additionally, or alternatively, the vehicle data may be identified to the specific user 112 based on the use of a key fob for entry of the vehicle 114 and/or detection of the key fob disposed in the vehicle 114 during the driving session(s) (whereby the key fob includes a unique identifier specific to the key fob, and also, the vehicle data for the user 112). It should be appreciated that the data may be identified to the user 112 by still other manners, including, for example, various inputs from the user 112 at the vehicle 114 (e.g., to a computing device associated with the vehicle 114, etc.), or a learning by the vehicle 114 and/or the authentication hub 136 based on the different vehicle data captured for the user 112, etc., whereby different users may be identified and segregated, etc.

In connection therewith, the vehicle 114, or authentication hub 136, generally includes a format for the vehicle data to be included in the user vehicle profile. For example, when a turn signal usage parameter is included in the user vehicle profile, the authentication hub 136 counts triggers on the use of the turn signal 120 (either right or left) and further triggers on the vehicle turning (either right or left). In this manner, the authentication hub 136 determines, for the user 112, the average usage of the turn signal 120, or more specifically, the right turn signal and the left turn signal. Likewise, the authentication hub 136 may determine a percentage of time that the user's hands are positioned at 10 and 2 o'clock on the steering wheel 116 (or other positions) by determining an interval of pressure at those location (via the sensors 128-130) over the interval of the driving session. This exemplary data gathering may be extended, by the authentication hub 136, to each parameter or input included in the form of the user vehicle profile.

That said, Table 1 includes an example user profile for the user 112, based on data collected by the vehicle 114 and/or the authentication hub 136 over one or more driving sessions.

TABLE 1

| Vehicle Input | User Vehicle Profile | |
|---|---|---|
| Turn signal, right | 65% | usage |
| Turn signal, left | 30% | usage |
| Steering wheel | 15.8 | kilograms |
| pressure sensors | | |
| Steering wheel | Two hands at 10 and 2 o'clock 40%; | |
| hand position | one hand at 6 o'clock 50% | |
| Seat position | Memory entry #1 | |
| Seat pressure | 104.3 | kilograms |
| Cruise control | 70% over 50 mph | |
| usage | | |
| Climate control | June to September average 68° F., AUTO; October | |
| | to November average 70° F.; December to March | |
| | average 72° F., DEF; April to May average 69° F. | |
| Entertainment | Radio station A (70%), Radio Station B (25%), | |
| system | and Radio Station C (5%) | |
| Shift knob pressure | 29.4 | kilograms |

Notwithstanding Table 1, it should be appreciated that the user vehicle profile may be different in other method embodiments.

For example, the user vehicle profile may include only turn signal usage for turns during the driving session(s), or the user vehicle profile may include turn signal usage in combination with steering wheel pressure and/or position data. Additionally, or alternatively, entertainment system usage may include a time of listening to particular stations during a driving session versus other stations (e.g., the profile may indicate that the user 112 listens to one of five particular stations for 95% of the time, etc.), and shift knob usage may include finger placement on the shift knob 124 through sensor data (e.g., indicating where the user has consistently been holding the shift knob 124, or where the user 112 routinely places his/her thumb/fingers during use, etc.). It should be appreciated that one or more of the contents of the user vehicle profile may be selected (and/or used in combination with each other) based on a degree of confidence desired in relying on the authentication provided thereby. As such, the differences in the user vehicle profiles may be based on a desired and/or required confidence in the authentication (whereby more content may be included in the user vehicle profile when added confidence in the authentication is required, for instance, in rental vehicles where multiple different users may drive the vehicles, etc.) or potentially, limitations on the vehicle 114 (e.g., number or types of sensors, etc.). Further, it should also be appreciated that several of the features included in the user vehicle profile may require longer durations of data collection to become acceptable or reliable (e.g., the climate control feature may require longer durations to account for climate changes, etc.).

And, the second way that the user 112 is registered to the vehicle 114, is that the vehicle 114 is provisioned with a payment account credential for the user's payment account issued by the issuer 108 (e.g., by the payment network 106 or the issuer 108, etc.). In this example, the payment account credential will include a payment token specific to the vehicle 114, whereby the token is bound to the vehicle 114 (and/or the authentication hub 136) and is only useable from the vehicle 114, etc.

With reference now to FIG. 3, when the user 112 initiates a driving session and pulls into a vehicle accessible merchant, for example, such as the merchant 102 (e.g., a drive through associated with the merchant, a gas station, etc.), as part of the current driving session, the user 112 may select to initiate a payment transaction with the merchant 102 for one or more desired products. The user 112 may then decide to pay for the product(s) with the vehicle 114, by way of the payment account credential provisioned to the vehicle 114, whereby the user 112 indicates the same to the vehicle 114. In one example, a presentation device included in the vehicle 114 may include a “CarPay” option (broadly, a payment option) whereby when the user 112 selects the option, via an input device (e.g., via an input to accept the pay option at a touchscreen input device (e.g., at the entertainment system 126, etc.), a voice command to a hands-free voice recognizable input device, etc.), and the input from the user 112 is received by the vehicle 114. In turn, the vehicle 114 provides the input to the authentication hub 136 as a request for a payment account credential (which is also a request to authenticate the user 112 because authentication is a necessity, in this embodiment, to provide the payment account credential to the merchant 102). In turn, the authentication hub 136 receives, at 302, the request to authenticate the user 112 of the vehicle 114 based on the input of the selected payment option.

Separately, from the initiation of the current driving session, the authentication hub 136 captures, at 304, vehicle data from the vehicle 114 for the user 112. In general, the vehicle data for the user 112, for the current driving session, is captured by the authentication hub 136 (or the vehicle 114) during the driving session, even without the request from the user 112. It should be appreciated that the authentication hub 136 captures the vehicle data for the current driving session in the same manner (and generally in the same format) as when it compiled the user vehicle profile for the user 112. As such, the description above with regard to Table 1 and the data collected for the user vehicle profile of the user 112 similarly applies to the data collected during the instant driving session. In connection therewith, Table 2 includes example data that may be collected/captured by the vehicle 114 and/or the authentication hub 136 for the current driving session.

TABLE 2

| Vehicle Input | Vehicle Data Description |
|---|---|
| Turn signal, right | Number of right turn signals divided by number of |
| | right turns |
| Turn signal, left | Number of left turn signals divided by number of |
| | left turns |
| Steering wheel | Pressure indicated by sensors 128-130 |
| pressure sensors | |
| Steering wheel | Interval of two hands positioned at 10 and 2 o'clock |
| hand position | divided by the interval of the driving session; |
| | Interval of one hand positioned at 6 o'clock |
| | divided by the interval of the driving session |
| Seat position | Select memory of position of seat 118 |
| Seat pressure | Pressure indicated by sensor 132 |
| Cruise control | Interval of cruise control usage divided by interval |
| usage | for which the vehicle 114 is traveling at or above |
| | 50 mph |
| Climate control | Temperature setting, taking into account current |
| | month/season |
| Entertainment | Percentage of driving session spent listing to partic- |
| system | ular radio stations (or to standard radio stations |
| | versus non-standard radio stations) |
| Shift knob pressure | Pressure indicated by sensor 134 and/or positioning |
| | of hand on shift knob 124 |

And, Table 3 includes example data values that may be collected/captured by the vehicle 114 and/or the authentication hub 136 for the current driving session of the user 112 (again, generally in the same manner (and generally in the same format) as when captured for the user vehicle profile for the user 112).

TABLE 3

| Vehicle Input | Captured Vehicle Data for User 112 | |
|---|---|---|
| Turn signal, right | 70% | usage |
| Turn signal, left | 25% | usage |
| Steering wheel pressure | 16.4 | kilograms |
| sensors | | |
| Steering wheel hand | Two hands at 10 and 2 o'clock 38%; | |
| position | one hand at 6 o'clock 37% | |
| Seat position | Memory entry #1 | |
| Seat pressure | 102.7 | kilograms |
| Cruise control usage | 0% [no speed over 50 mph] | |
| Climate control | June, 68° F., AUTO | |
| Entertainment system | Radio station A (60%), Radio Station B | |
| | (35%), and Radio Station C (1%) | |
| Shift knob pressure | 31.5 | kilograms |

Then in the method 300, in response to the request for authentication of the user 112, the authentication hub 136 compares, at 306, the captured vehicle data for the current driving session (e.g., from Table 3, etc.) to the user vehicle profile for the user 112 (e.g., from Table 1, etc.). In connection therewith, Tables 4 and 5 illustrates the results of the comparison. In particular, Table 4 includes a side-by-side comparison of the captured vehicle data for the current driving session for the user 112 in the above example (from Table 3) and the corresponding data from the user vehicle profile for the user 112 (from Table 1). And, Table 5 then includes an analysis (e.g., as performed by the authentication hub 136, etc.) of the data included in Table 4.

TABLE 4

| Vehicle Input | User Vehicle Profile | | Captured Vehicle Data | |
|---|---|---|---|---|
| Turn signal, right | 65% | usage | 70% | usage |
| Turn signal, left | 30% | usage | 25% | usage |
| Steering wheel pressure sensors | 15.8 | kilograms | 16.4 | kilograms |
| Steering wheel hand position | Two hands at 10 and 2 o'clock | | Two hands at 10 and 2 o'clock | |
| | 40%; one hand at 6 o'clock 50% | | 38%; one hand at 6 o'clock 37% | |
| Seat position | Memory entry #1 | | Memory entry #1 | |
| Seat pressure | 104.3 | kilograms | 102.7 | kilograms |
| Cruise control usage | 70% over 50 mph | | 0% [no speed over 50 mph] | |
| Climate control | June to September 68° F., AUTO; | | June, 68° F., AUTO | |
| | October to November 70° F.; | | | |
| | December to March 72° F., DEF; | | | |
| | April to May 69° F. | | | |
| Entertainment system | Radio station A (70%), | | Radio station A (60%), | |
| | Radio Station B (25%), | | Radio Station B (35%), | |
| | and Radio Station C (5%) | | and Radio Station C (1%) | |
| Shift knob pressure | 29.4 | kilograms | 31.5 | kilograms |

| Vehicle | Deviation | Weight | Deviation | Pass (1)/ | Valua- |
|---|---|---|---|---|---|
| Input | (%) | Value | Threshold | Fail (0) | tion |
| Turn signal, | 5% | 0.15 | 5% | 1 | 0.1425 |
| right | | | | | |
| Turn signal, | 5% | 0.15 | 5% | 1 | 0.1425 |
| left | | | | | |
| Steering wheel | 3.80% | 0.3 | 5% | 1 | 0.285 |
| pressure | | | | | |
| sensors | | | | | |
| Steering wheel | 2% and | 0.25 | 10% | 0 | 0 |
| hand position | 13% | | | | |
| Seat position | Match | 0.1 | 5% | 1 | 0.095 |
| Seat pressure | 1.53% | 0.1 | 10% | 1 | 0.09 |
| Cruise control | Insuf- | 0.1 | 10% | 0 | 0 |
| usage | ficient | | | | |
| | Input | | | | |
| Climate control | Match | 0.1 | 10% | 1 | 0.09 |
| Entertainment | Match | 0.1 | 5% | 1 | 0.095 |
| system | | | | | |
| Shift knob | 7% | 0.2 | 5% | 0 | 0 |
| pressure | | | | | |

As shown in Table 5, the analysis includes, in this example, a determination of a deviation (or difference) between the data for each vehicle input (as an absolute value) from Table 4, a weight value for each vehicle input (e.g., based on a reliability of the given input, based on an importance of the given input, etc.), a deviation threshold for the given input (e.g., within about 15.0%, within about 10.0%, within about 5.0%, etc.), a pass or fail indication for the calculated deviation as compared to the deviation threshold, and a resulting valuation for the vehicle input (as a product of the weight value, the threshold value, and the pass/fail value). In this example, the entertainment system input is considered a substantial match because the user 112 listened to the same radio stations for at least 95% of the driving session. And, from this data, the authentication hub 136 is able to generate a confidence score regarding the authentication of the user 112. In particular in this example, the confidence score is a sum of the valuations generated for each of the vehicle inputs, i.e., 0.94 (or 94%).

It should be appreciated that the weight values and deviation thresholds provided in Table 5 are exemplary in nature, and that other values may be used in other embodiments. It should also be appreciated that such values may be set in some embodiments by the authentication hub 136 and/or authentication hub server 140, while in other embodiments the issuer 108 may set one or more of the values or at least provide input as to the settings (e.g., if the issuer 108 needs a higher level of confidence for different ones of the inputs, etc.).

Given the above, the authentication hub 136 next determines, at 308, whether or not there is a substantial match between the user 112 in the current driving session and the user vehicle profile for the user 112. In particular in this example, the authentication hub 136 compares the confidence score generated for the different vehicle inputs to a threshold. And, when the confidence score satisfies the threshold, the authentication hub 136 determines that the user 112 driving the vehicle 114 during the current session is in fact the user 112. In the above example, the authentication hub 136 calculates a confidence score of 94% which would satisfy a threshold of 90%. It should be appreciated that the threshold may be defined by the authentication hub 136, the authentication hub server 140, or the issuer 108 as appropriate to ensure a sufficient level of confidence that the user of the vehicle 114 is in fact the user 112.

That said, when there is no match (at 308), the authentication hub 136 responds to the authentication request, from the user 112, at the presentation device of the vehicle 114 (e.g., the output device 206, etc.), indicating a failed authentication, at 310. Conversely, when there is a substantial match (e.g., the confidence score satisfies a predefined threshold, etc.), the authentication hub 136 retrieves, at 312, the payment account credential for the user 112 from memory (e.g., the memory 204, etc.) and wirelessly emits, at 314, the payment account credential, along with the identifier of the vehicle 114, via the side mirror 138 in this example (e.g., via network interface 210 (e.g., NFC transmitter), etc. included therein). Additionally, the authentication hub 136 responds to the authentication request from the user 112, at the output device 206 of the vehicle 114 (e.g., the presentation device, etc.) indicating a successful authentication, at 316.

In response to the successful notification, the user 112 informs the merchant 102, or an employee, manger, etc., thereof, of the payment at the side mirror 138, whereby the employee, manager, etc. taps the POS terminal 142 at the side mirror 138 (or brings it within proximity of the side mirror 138 if not already done), whereupon the POS terminal 142 captures the payment account credential and the vehicle identifier.

The POS terminal 142 then compiles and transmits an authorization request for the transaction, including at least the payment account credential, to the acquirer 104. The acquirer 104 communicates the authorization request with the issuer 108, through the payment network 106. In response, the issuer 108 determines whether the payment account is in good standing and whether there is sufficient funds and/or credit to cover the transaction. If approved, an authorization reply (indicating the approval of the transaction) is compiled by and transmitted from the issuer 108 to the merchant 102, thereby permitting the merchant 102 to complete the transaction with the user 112 (e.g., by delivering the product ordered by the user 112, etc.). The transaction is later cleared and/or settled by and between the merchant 102, the acquirer 104, and the issuer 108. If declined, however, the authorization reply (indicating a decline of the transaction) is compiled by issuer 108 and provided back to the merchant 102, thereby permitting the merchant 102 to halt or terminate the transaction, or request alternative forms of payment.

In view of the above, the systems and methods herein permit use of driving behaviors of a user, in a vehicle, to provide a user vehicle profile, which may be used, in connection with payment account transaction, for example, to authenticate the user. In this manner, authentication is based on a driver's behaviors within the vehicle as inputs to establish a user vehicle profile in connection with one or more purchases or other activities while the user is disposed within and/or at the vehicle. The inventors hereof have discovered that drivers are sufficiently habitual when it comes to their driving tendencies, whereby a profile based on the same may be deployed as a mechanism of authentication, and whereby the authentication hub herein is permitted to rely on hand placement, grip and even their likelihood of using a turn signal (or more or less as described above) to determine, based on a profile, that a Driver X is in fact Driver X and not his spouse or child or another user.

What's more, the vehicle data captured from the vehicle and/or the user vehicle profile may be employed as a safety mechanism, restricting particular functions (e.g., the entertainment system (e.g., radio, etc.), temperature controls, etc.) depending on the specific user, and/or if there is no active hand placement by the user within a predefined period of time, to inhibit certain driving behaviors (e.g., reckless driving, etc.). What's more, the user vehicle profile may be employed to identify unauthorized drivers and consequently notify the authorities or cease certain operations of the vehicle (e.g., shut off the vehicle, etc.) (e.g. thereby preventing “joyriding” or having the owner's children's friends driving for fun, etc.). Further, in a vehicle rental scenario, the user vehicle profile may be employed to inhibit drivers other than the expected drivers from operating the vehicle (when not authenticated).

In some embodiments, an interlock scenario may be utilized, whereby a user may be required to provide a breath sample to a BAC meter associated with an ignition lock of a vehicle, for instance, as an added verification of the user (e.g., as another user input (e.g., a biometric input, etc.), etc.). Here, the interlock device may only be removed or deactivated by a particular user, thereby providing another system for validating that the user driving the vehicle is in fact the user for which the user vehicle profile is associated and not someone else.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations: (a) capturing, by an authentication hub computing device, vehicle data for a user during a driving session of the user at a vehicle (e.g., where the vehicle data is associated with at least one of: a steering wheel, a turn signal, a seat, and an entertainment system of a vehicle; etc.); (b) in response to a request to authenticate the user during the driving session, comparing, by the authentication hub computing device, the vehicle data captured during the driving session to a user vehicle profile associated with an identified user and stored in a memory; (c) emitting, by the authentication hub computing device, via a wireless network adapter, a token associated with the user vehicle profile, during the driving session, in response to the vehicle data captured during the driving session substantially matching the user vehicle profile, thereby indicating authentication of the user as the identified user; and (d) receiving, by the receiving the request to authenticate the user from the vehicle, in response to a user input to the vehicle computing device, the request to authenticate the user from the vehicle, in response to a user input to the vehicle.

With that said, exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” and the phrase “at least one of” includes any and all combinations of one or more of the associated listed items.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

Although the terms first, second, third, etc. may be used herein to describe various elements and operations, these elements and operations should not be limited by these terms. These terms may be only used to distinguish one element or operation from another element or operation. Terms such as “first,” “second,” and other numerical terms when used herein do not imply a sequence or order unless clearly indicated by the context. Thus, a first element operation could be termed a second element or operation without departing from the teachings of the exemplary embodiments.

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A system for facilitating authentication of a user through a user vehicle profile, the system comprising:
a memory including a user vehicle profile associated with an identified user of a vehicle and a token associated with the user vehicle profile;
a side mirror of the vehicle, the side mirror including a network interface configured to wirelessly emit the token;
at least one of a steering wheel and/or a turn signal of the vehicle; and
at least one processor coupled in communication with the memory, the network interface of the side mirror, and the at least one of the steering wheel and/or the turn signal;
wherein the at least one processor is configured to:
capture vehicle data associated with the at least one of the steering wheel and/or the turn signal during a driving session of a user driving the vehicle;
in response to a request to authenticate the user driving the vehicle, compare the vehicle data captured during the driving session to the user vehicle profile stored in the memory for the identified user of the vehicle; and
causing the token to be emitted from the network interface of the side mirror when the vehicle data captured during the driving session substantially matches the user vehicle profile, thereby indicating authentication of the user driving the vehicle as the identified user.

2. The system of claim 1, wherein the system includes the steering wheel of the vehicle;
wherein the steering wheel includes at least one sensor; and
wherein the at least one processor is configured to capture the vehicle data from said at least one sensor during the driving session.

3. The system of claim 1, wherein the at least one processor is further configured to identify the captured vehicle data to the user based on at least one of a key fob specific to the user and/or a communication device associated with the user.

4. The system of claim 1, wherein the system includes the steering wheel and the turn signal of the vehicle; and
wherein the user vehicle profile includes:
a usage of the turn signal by the identified user; and
at least one of a hand position of the identified user on the steering wheel and a pressure applied, by the identified user, to the steering wheel.

5. The system of claim 1, further comprising a seat of the vehicle, the seat including at least one sensor configured to capture a weight of the user when sitting in the seat; and
wherein the user vehicle profile includes a weight for the identified user.

6. The system of claim 5, wherein the network interface includes a near-field communication (NFC) interface; and
wherein the driving session is defined by a presence of the user in the seat of the vehicle as determined by the at least one sensor of the seat.

7. The system of claim 5, further comprising an entertainment system of the vehicle; and
wherein the user vehicle profile includes a pattern of inputs to the entertainment system by the identified user.

8. The system of claim 1, further comprising a touchscreen device of the vehicle configured to display a pay option to the user driving the vehicle and to accept an input to the pay option by the user driving the vehicle, and to provide the input to the pay option to the at least one processor; and
wherein the at least one processor is configured to receive the input to the pay option as the request to authenticate the user driving the vehicle.

9. The system of claim 1, further comprising the vehicle, the steering wheel of the vehicle, and the turn signal of the vehicle;
wherein the vehicle includes the memory, the side mirror, the steering wheel, the turn signal, and the at least one processor.

10. A computer-implemented method for authenticating a user based on a user vehicle profile, the method comprising:
capturing, by an authentication hub computing device, vehicle data for a user during a driving session of the user at a vehicle;
in response to a request to authenticate the user during the driving session, comparing, by the authentication hub computing device, the vehicle data captured during the driving session to a user vehicle profile associated with an identified user and stored in a memory; and
emitting, by the authentication hub computing device, via a wireless network adapter, a token associated with the user vehicle profile, during the driving session, in response to the vehicle data captured during the driving session substantially matching the user vehicle profile, thereby indicating authentication of the user as the identified user.

11. The computer-implemented method of claim 10, wherein the token includes a payment account credential for a payment account issued to the identified user.

12. The computer-implemented method of claim 10, wherein the wireless network adaptor is included in a side mirror of the vehicle.

13. The computer-implemented method of claim 10, further comprising receiving the request to authenticate the user from the vehicle, in response to a user input to the vehicle.

14. The computer-implemented method of claim 10, wherein emitting the token in response to the vehicle data captured during the driving session substantially matching the user vehicle profile includes emitting the token in response to at least one parameter of the captured vehicle data satisfying a deviation threshold of said at least one parameter included in the user vehicle profile.

15. The computer-implemented method of claim 14, wherein the at least one parameter includes a weight of the user, a grip pressure of the user, and/or a hand position of the user on a steering wheel.

16. The computer-implemented method of claim 15, wherein the at least one parameter further includes usage of a first station at an entertainment system of the vehicle and/or usage of a turn signal of the vehicle.

17. A non-transitory computer-readable storage medium including executable instructions, which when executed by at least one processor, cause the at least one processor to:
capture vehicle data for a user, during a driving session of the user at a vehicle, from multiple sensors disposed within the vehicle;
receive a request to initiate a transaction, during the driving session, funded by a payment token provisioned to the vehicle;
in response to said request, compare the captured vehicle data to a user vehicle profile associated with an identified user stored in a memory; and
emit, via a wireless network adapter, the payment token provisioned to the vehicle and associated with the user vehicle profile, during the driving session, in response to the vehicle data captured during the driving session substantially matching the user vehicle profile, thereby permitting the transaction to be initiated by a merchant receiving the emitted payment token.

18. The non-transitory computer-readable storage medium of claim 17, wherein the executable instructions, when executed by the at least one processor, cause the at least one processor to receive the request to initiate the transaction in response to an input to the vehicle selecting a vehicle payment option.

19. The non-transitory computer-readable storage medium of claim 17, wherein the wireless network adapter is coupled to the vehicle.

20. The non-transitory computer-readable storage medium of claim 19, wherein the at least one processor is disposed within the vehicle.
